(19) United States
(12) Patent Application Publication
(10) Pub. No.: US 2015/0202745 A1
(43) Pub. Date: Jul. 23, 2015

(54) PLIER STRUCTURE

(71) Applicant: JUN-FAN CHEN, Taichung City (TW)

(72) Inventor: JUN-FAN CHEN, Taichung City (TW)

(21) Appl. No.: 14/160,559

(22) Filed: Jan. 22, 2014

(51) Int. Cl. B25B 7/14; B25B 7/08

(52) U.S. Cl. CPC B25B 7/14; B25B 7/08

(57) ABSTRACT

A plier structure contains a body, and the body includes a first plier part, a second plier part and a releasing member. A middle section of the first plier part is rotatably connected and crossed with a middle section of the second plier part. The body also includes a clamping segment and an operating segment for controlling the clamping segment, the first plier part has an oblique tooth segment, the releasing member is slidably fitted on the second plier part, and the second plier part has a guiding recess for retaining with the releasing member such that a largest sliding distance of the releasing member is limited. The releasing member has a torsion spring abutting against the releasing member and inserted into a notch of the second plier part, the releasing member also has a serrated protrusion pushed by the torsion spring and engaging with the oblique tooth segment.

### FIELD OF THE INVENTION

The present invention relates to a plier structure which is capable of limiting a clamping angle by ways of a tooth segment and a serrated protrusion.

### BACKGROUND OF THE INVENTION

Pipeline system, such as gas delivery pipeline, liquid oil pipeline, water pipeline, contains flexible pipe fittings connected with containers or pipe joints of valves via various pipe adapters (such as pipe tee or elbow pipes). To fix the pipe fittings and the pipe adapters or the pipe adapters securely, a plurality of cable ties are tied around an outer peripheral side of the pipe fittings, and each cable tie has a flexible band and two tabs, when the two tabs are retained together, the pipe fittings are tied fixedly.

However, when manually removing the two tabs, user's fingers hurt easily. To solve this problem, a needle-nose pliers are applied to remove the two tans of the cable tie, but a clamping face of two clamp edges of the needle-nose pliers and the two tabs slide easily, so the two tabs slide out of the clamping range of the clamping face, thus operating the needle-nose pliers difficultly.

The present invention has arisen to mitigate and/or obviate the afore-described disadvantages.

### SUMMARY OF THE INVENTION

The primary object of the present invention is to provide a plier structure which is capable of limiting a clamping angle by ways of a tooth segment and a serrated protrusion.

To obtain the above objective, a plier structure provided by the present invention contains:

a body, and the body including a first plier part, a second plier part and a releasing member.

A middle section of the first plier part is rotatably connected with and is crossed with a middle section of the second plier part, the body also includes a clamping segment defined on a first end thereof and an operating segment formed on a second end thereof and used to control the clamping segment, the first plier part has an oblique tooth segment arcuately arranged around a peripheral side of the middle section thereof, the releasing member is slidably fitted on the middle section of the second plier part, and the second plier part has a guiding recess for retaining with the releasing member such that a largest sliding distance of the releasing member is limited, the releasing member has a torsion spring disposed therein, and a first foot of the torsion spring abuts against the releasing member, a second foot of the torsion spring is inserted into a notch of the second plier part, the releasing member also has a serrated protrusion formed on one end thereof, pushed by the torsion spring, and engaging with the oblique tooth segment.

### BRIEF DESCRIPTION OF THE DRAWINGS

FIG. 1 is a perspective view showing the exploded components of a plier structure according to a preferred embodiment of the present invention.

FIG. 2 is a perspective view showing the assembly of the plier structure according to the preferred embodiment of the present invention.

FIG. 3 is another perspective view showing the assembly of the plier structure according to the preferred embodiment of the present invention.

FIG. 4 is an amplified perspective view showing the assembly of a releasing member of the plier structure according to the preferred embodiment of the present invention.

FIG. 5 is a perspective view showing the operation of the plier structure according to the preferred embodiment of the present invention.

FIG. 6 is another perspective view showing the operation of the plier structure according to the preferred embodiment of the present invention.

FIG. 7 is a perspective view showing the operation of a part of the plier structure according to the preferred embodiment of the present invention.

FIG. 8 is a perspective view showing the application of the plier structure according to the preferred embodiment of the present invention.

### DETAILED DESCRIPTION OF THE PREFERRED EMBODIMENTS

A plier structure according to a preferred embodiment of the present invention is capable of limiting a clamping angle and is operated easily.

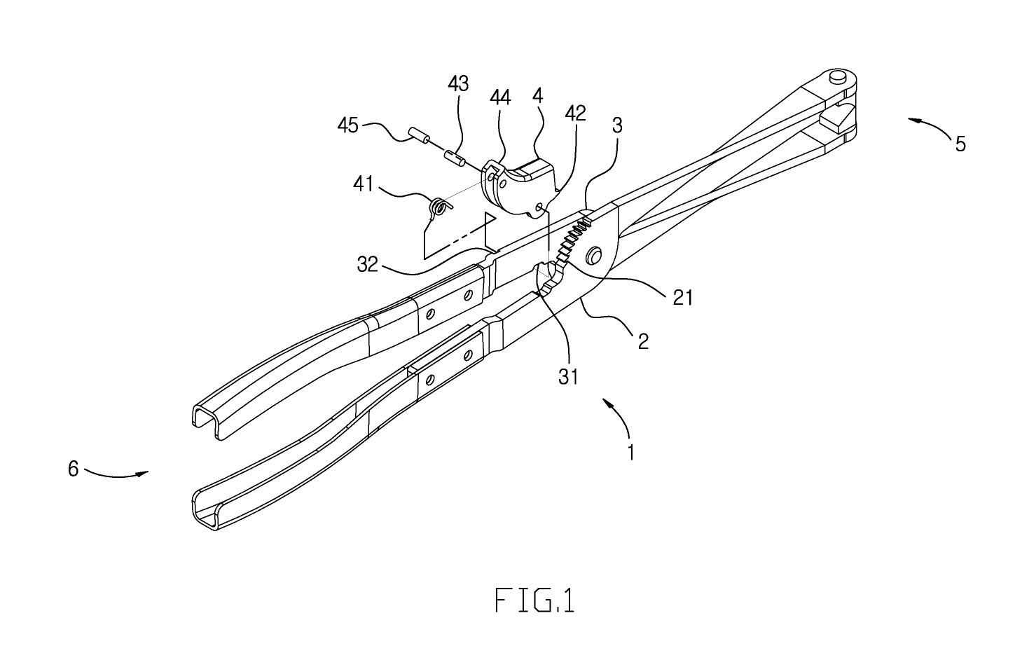

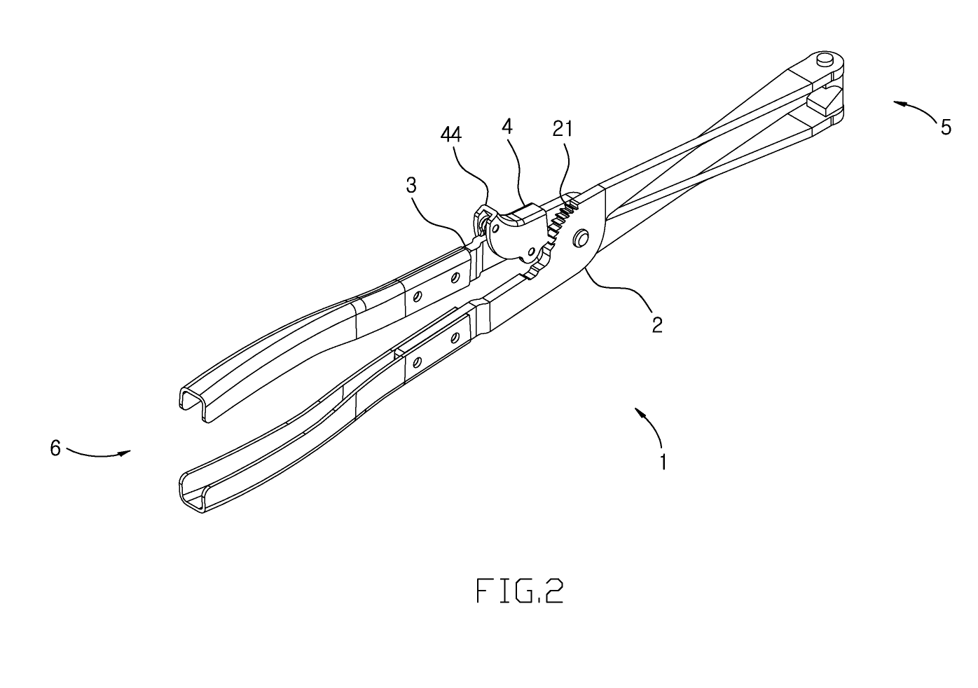

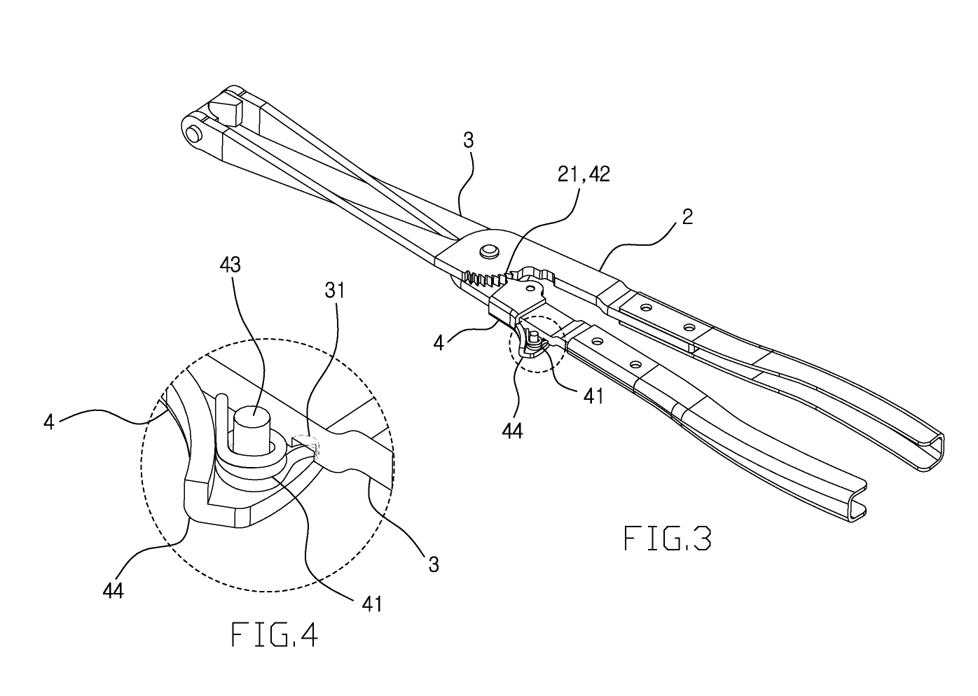

With reference to FIGS. 1-7, a plier structure according to a preferred embodiment of the present invention comprises: a body 1, and the body 1 includes a first plier part 2, a second plier part 3 and a releasing member 4.

A middle section of the first plier part 2 is rotatably connected with and is crossed with a middle section of the second plier part 3, the body 1 also includes a clamping segment 5 defined on a first end thereof and an operating segment 6 formed on a second end thereof and used to control the clamping segment 5. The first plier part 2 has an oblique tooth segment 21 arcuately arranged around a peripheral side of the middle section thereof (the oblique tooth segment 21 has a plurality of oblique teeth, and each oblique tooth is defined by an inclined face and a vertical face connecting with the inclined face), the releasing member 4 is slidably fitted on the middle section of the second plier part 3, and the second plier part 3 has a guiding recess 31 for retaining with the releasing member 4 such that a largest sliding distance of the releasing member 4 is limited, the releasing member 4 has a torsion spring 41 disposed therein, and a first foot of the torsion spring 41 abuts against the releasing member 4, a second foot of the torsion spring 41 is inserted into a notch 32 of the second plier part 3. The releasing member 4 also has a serrated protrusion 42 (wherein the serrated protrusion 42 is defined by an inclined face and a vertical face coupling with the inclined face) formed on one end thereof, pushed by the torsion spring 41, and engaging with the oblique tooth segment 21, and when the serrated protrusion 42 engages with the oblique tooth segment 21, the inclined face of the serrated protrusion 42 corresponds to an inclined face of a first oblique tooth and the vertical face of the serrated protrusion 42 corresponds to the vertical face of the first oblique tooth.

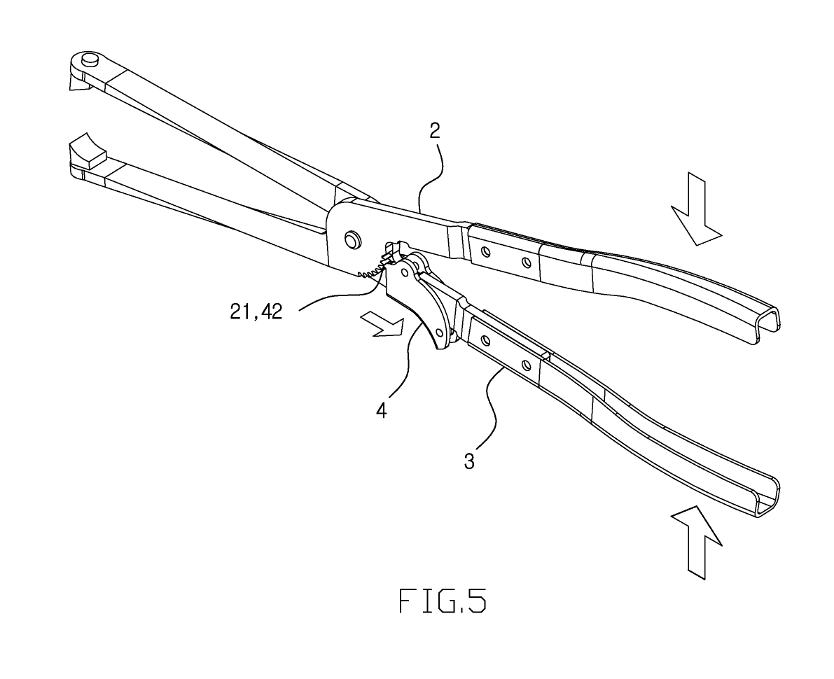

In operation, the operating segment 6 of the body 1 is pressed so that the inclined face of the oblique tooth segment 21 and the inclined face of the serrated protrusion 42 push each other, to drive the releasing member 4 to press the torsion spring 41, and then the torsion spring 41 pushes the serrated protrusion 42 to engage with a second oblique tooth of the oblique tooth segment 21 (as shown in FIG. 5), thereby adjusting a clamping angle of the clamping segment 5.

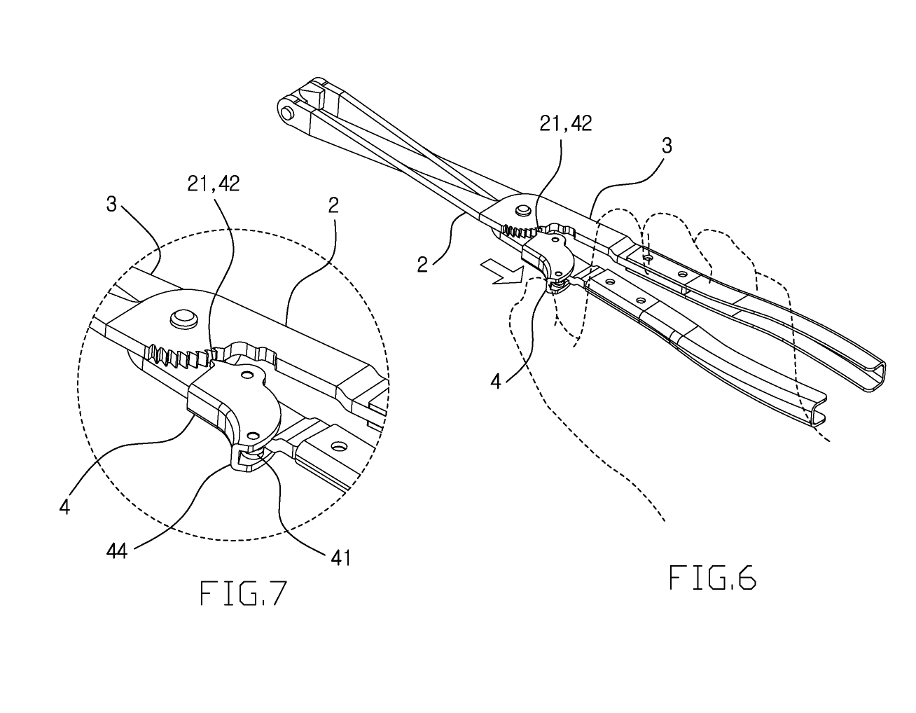

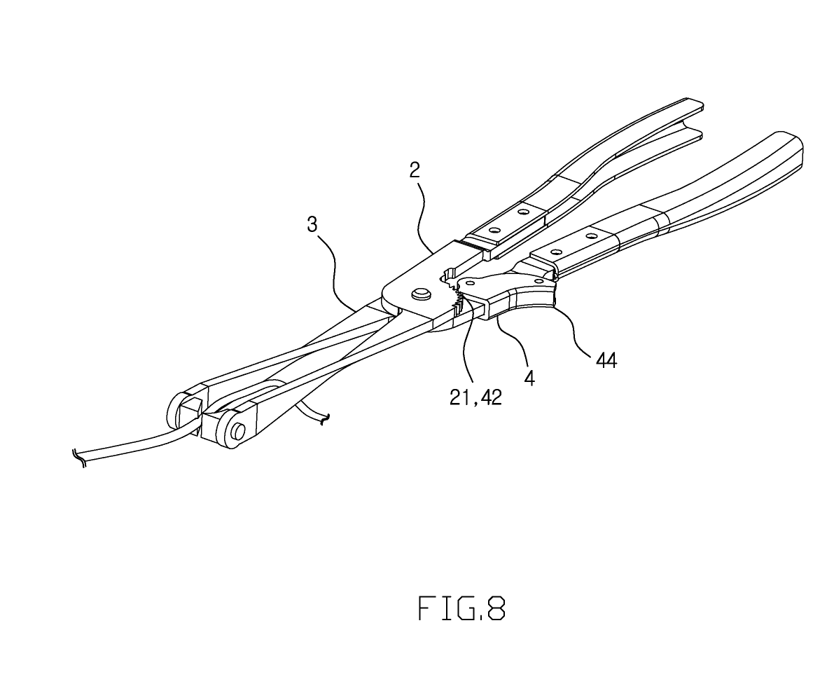

When the clamping segment 5 is expended outwardly, the releasing member 4 is pulled backwardly so that the serrated protrusion 42 disengages from the oblique tooth segment 21, hence a positioning limitation of the first plier part 2 and the second plier part 3 (as illustrated in FIGS. 6 and 7) is released, and the operating segment 6 and the clamping segment 5 of the body 1 are expended.

It is to be noted that the releasing member 4 is in a U shape and covers a part of the second plier part 3, the releasing member 4 further has a positioning post 43 inserted into the guiding recess 31, such that the releasing member 4 is slidably fixed on the second plier part 3 by ways of the positioning post 43.

Preferably, the releasing member 4 further including an arcuate pulling section 44 arranged on a distal end thereof and an accommodating space defined on an inner surface thereof opposite to the arcuate pulling section 44 so as to insert a coupling shaft 45 on which the torsion spring 44 is fitted, such that the pulling section 44 is pulled by a user to release a positioning limitation of the body 1.

Thereby, when the first plier part 2 and the second plier part 3 of the plier structure are pressed, a clamping direction of the first plier part 2 and the second plier part 3 is not limited, but an expending direction of the first plier part 2 and the second plier part 3 are limited, thus clamping a workpiece easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A plier structure comprising: a body, and the body including a first plier part, a second plier part and a releasing member; wherein
a middle section of the first plier part is rotatably connected with and is crossed with a middle section of the second plier part, the body also includes a clamping segment defined on a first end thereof and an operating segment formed on a second end thereof and used to control the clamping segment, the first plier part has an oblique tooth segment arcuately arranged around a peripheral side of the middle section thereof, the releasing member is slidably fitted on the middle section of the second plier part, and the second plier part has a guiding recess for retaining with the releasing member such that a largest sliding distance of the releasing member is limited, the releasing member has a torsion spring disposed therein, and a first foot of the torsion spring abuts against the releasing member, a second foot of the torsion spring is inserted into a notch of the second plier part, the releasing member also has a serrated protrusion formed on one end thereof, pushed by the torsion spring, and engaging with the oblique tooth segment.

2. The plier structure as claimed in claim 1, wherein the releasing member is in a U shape and covers a part of the second plier part, the releasing member further has a positioning post inserted into the guiding recess.

3. The plier structure as claimed in claim 1, wherein the releasing member further including an arcuate pulling section arranged on a distal end thereof and an accommodating space defined on an inner surface thereof opposite to the arcuate pulling section so as to insert a coupling shaft on which the torsion spring is fitted.
